(19) United States
(12) Patent Application Publication
(10) Pub. No.: US 2026/0245040 A1
(43) Pub. Date: Aug. 20, 2026

(54) METHOD AND SYSTEM FOR AUTOMATIC TAGGING OF CERTIFICATES IN A BUILDING MANAGEMENT SYSTEM

(71) Applicant: Honeywell International Inc., Charlotte, NC (US)

(72) Inventor: Bishal DEBBARMA, Bangalore (IN)

(21) Appl. No.: 19/056,750

(22) Filed: Feb. 19, 2025

(51) Int. Cl. G06Q 10/10; G06F 40/117

(52) U.S. Cl. CPC G06Q 10/10; G06F 40/117

(57) ABSTRACT

The present disclosure relates to a method for automatic tagging of certificates in a building management system. The method comprises steps of receiving, at a certificate tagging system, a certificate of a building management system. The method further includes extracting a plurality of certificate data and a plurality of system context data from the certificate. The method further includes processing the plurality of certificate data to determine a first set of rules for the plurality of certificate data and processing the plurality of system context data to determine a second set of rules using the building management system to further establish relationships and hierarchies. The method further includes creating one or more tags based on the processed plurality of certificate data and the processed plurality of system context data and adding the one or more tags to the certificate of the building management system.

### TECHNICAL FIELD

The present disclosure relates to certificate tagging methods. More particularly, the present disclosure relates to a method for automatic tagging of certificates in a building management system.

### BACKGROUND

At the outset, manually tagging and tracking each certificate within a Business Management System (BMS) can be a highly time-consuming and labour-intensive process. This task demands a significant amount of human effort, as employees must manually enter and categorize certificates with precision. Instead of focusing on more strategic and value-added tasks, valuable resources are spent on these repetitive activities. This not only reduces productivity but also diverts attention from tasks that could have a greater impact on the organization's growth and efficiency.

Further, the reliance on manual processes introduces a higher likelihood of errors. Incorrect tagging, missing tags, or misclassifications are common pitfalls in manual systems. These mistakes can have profound consequences, particularly in compliance-sensitive environments. For instance, a missing or incorrectly tagged certificate could lead to compliance violations, which could result in costly penalties or legal complications. Additionally, such errors can create delays during audits, as auditors may struggle to locate and verify the necessary documents. These mistakes not only cause frustration but also compromise the integrity of the entire system.

Another critical drawback of manual certificate management is the lack of scalability. As an organization grows and the number of certificates increases, the manual system becomes more cumbersome and difficult to manage. The process that was once manageable when the volume of certificates was low becomes increasingly inefficient and prone to errors. The administrative burden expands, and the ability to keep up with the growing volume of work diminishes. This lack of scalability hampers the organization's ability to adapt to changing demands or expand efficiently.

In addition to scalability challenges, manual tagging and tracking hinder the accessibility and integration of data with other automated systems. Real-time reporting and decision-making are limited by the lack of automation, as it takes time to compile and organize the necessary data manually. This delay reduces the responsiveness of the organization to emerging issues and market changes. The inability to integrate seamlessly with other digital tools also means that valuable data is often preventing a comprehensive, real-time view of the organization's certificate management status. Without automation, key performance indicators and insights are less readily available, which in turn reduces the overall efficiency and effectiveness of the BMS.

In conclusion, manual certificate tagging and tracking is a significant barrier to optimizing operational efficiency, compliance, and scalability. It requires immense human effort and is prone to errors and restricts data accessibility and real-time decision-making. For businesses looking to enhance their BMS, adopting automated systems for certificate management can help streamline processes, improve accuracy, and unlock greater efficiency.

Therefore, there exists a significant opportunity to improve manual certificate tagging by developing tools that are simple, automated, optimize time and resources, and improve the overall productivity and efficiency of BMS by certificate tagging and tracking.

### SUMMARY

This disclosure provides a method for automatic tagging of certificates in a building management system and a system thereof.

In an embodiment, a method for automatic tagging of certificates in a building management system is disclosed. The method includes receiving, at a certificate tagging system, a certificate of a building management system. The method further includes extracting a plurality of certificate data and a plurality of system context data from the certificate. The method further includes processing the plurality of certificate data to determine a first set of rules for the plurality of certificate data and processing the plurality of system context data to determine a second set of rules using the building management system to further establish relationships and hierarchies. The method further includes creating one or more tags based on the processed plurality of certificate data and the processed plurality of system context data. The method further includes adding the one or more tags to the certificate of the building management system.

In some embodiments, the method further comprises the creating one or more tags comprising collecting one or more intermediary tags based on the processed plurality of certificate data and the processed plurality of system context data. The method further includes formatting the one or more intermediary tags to standardize a format of the one or more intermediary tags and normalize at least one value of the one or more intermediary tags. The method further includes identifying the one or more intermediary tags which are duplicate and resolving conflicting values of the one or more intermediary tags. The method further includes categorizing the one or more intermediary tags in a group.

In some embodiments, the method further comprises validating the categorized one or more intermediary tags in the group via the first set of rules and the second set of rules.

In some embodiments, the method further comprises processing the validated one or more intermediary tags to form a final set of tags and tagging the certificate with the final set of tags.

In some embodiments, the plurality of certificate data is selected from a group of specific data comprising a common name, a subject alternative name(s), an issuer information, a validity period, a key usage parameter, and technical specifications.

In some embodiments, the plurality of system context data is selected from a group of context data comprising a certificate name, a device type identifier, a system identifier, a zone identifier, and a domain information.

In some embodiments, the first set of rules is selected from a plurality of key strength assessment rules and a plurality of validity period rules.

In some embodiments, the processing the plurality of system context data to establish the relationships and hierarchies by setting a plurality of location rules, a plurality of equipment rules, and a plurality of integration rules.

In some embodiments, the tagged certificate comprises a certificate identifier, one or more tags, and a plurality of metadata.

In yet another embodiment, a certificate tagging system for automatic tagging of certificates is disclosed. The certificate tagging system includes a metadata extractor module configured to receive a certificate of a building management system and further configured to extract a plurality of certificate data and a plurality of system context data from the certificate. The system further includes a rules engine configured to process the plurality of certificate data to determine a first set of rules for the plurality of certificate data and further configured to process the plurality of system context data to determine a second set of rules using the building management system to further establish relationships and hierarchies. The system further includes a tag generation module configured to create one or more tags based on the processed plurality of certificate data and the processed plurality of system context data and further configured to add the one or more tags to the certificate of the building management system.

In some embodiments, the tag generation module includes a tag collection module configured to collect one or more intermediary tags based on the processed plurality of certificate data and the processed plurality of system context data. The tag generation module further includes a formatting module configured to format the one or more intermediary tags to standardize a format of the one or more intermediary tags and normalize at least one value of the one or more intermediary tags. The tag generation module includes a conflict resolution module configured to identify the one or more intermediary tags which are duplicate and resolve conflicting values of the one or more intermediary tags. The tag generation module further includes a categorization module configured to categorize the one or more intermediary tags in a group.

In some embodiments, the system further comprises a tagging module configured to validate the categorized one or more intermediary tags in the group via the first set of rules and second set of rules.

In some embodiments, the tagging module further configured to process the validated one or more intermediary tags to form a final set of tags and further configured to tag the certificate with the final set of tags.

In some embodiments, the plurality of certificate data is selected from a group of specific data comprising a common name, a subject alternative name(s), an issuer information, a validity period, a key usage parameter, and technical specifications.

In some embodiments, the plurality of system context data is selected from a group of context data comprising a certificate name, a device type identifier, a system identifier, a zone identifier, and a domain information.

In some embodiments, the first set of rules is selected from a plurality of key strength assessment rules and a plurality of validity period rules.

In some embodiments, the rules engine further configured to process the plurality of system context data to establish the relationships and hierarchies by setting a plurality of location rules, a plurality of equipment rules, and a plurality of integration rules.

In some embodiments, the tagged certificate comprises a certificate identifier, one or more tags, and a plurality of metadata.

In some embodiments, the system automatically fetches the certificate, and the second set of rules from the building management system.

In yet another embodiment, a non-transitory computer-readable medium is disclosed, having stored thereon computer-readable instructions that, when executed by a processor, cause the processor to execute a method for automatic tagging of certificates. The method comprises receiving a certificate of a building management system. The method includes extracting a plurality of certificate data and a plurality of system context data from the certificate. The method includes processing the plurality of certificate data to determine a first set of rules for the plurality of certificate data. The method further includes processing the plurality of system context data to determine a second set of rules using the building management system to further establish relationships and hierarchies. The method further includes creating one or more tags based on the processed plurality of certificate data and the processed plurality of system context data and adding the one or more tags to the certificate of the building management system.

As the manual certificate tagging and tracking is an antiquated practice that poses significant challenges for businesses striving for operational efficiency, compliance, and scalability. The process typically involves employees manually recording, updating, and cross-referencing certificate information, often across multiple systems or even physical records. This not only consumes considerable time and effort but also requires constant vigilance to ensure accuracy. The sheer volume of certificates, especially in industries like construction, manufacturing, and healthcare, can overwhelm staff, leading to bottlenecks and delays that affect overall productivity.

Moreover, the manual approach to certificate management severely restricts data accessibility and real-time decision-making. When certificate information is scattered across different systems or physical locations, it becomes challenging to access and analyse the data quickly. This lack of real-time insights can delay important decisions, such as whether a vendor, employee, or asset meets the necessary compliance standards. It also limits the ability to track certificate statuses across the entire supply chain or workforce efficiently. In industries where compliance and certification are critical to operations, this lag in information flow can hinder the organization's ability to act swiftly and appropriately.

To overcome these challenges, the automatic tagging of certificates in a Building Management System (BMS) is built. By integrating this solution that automatically track, update, and store certificate data, companies can eliminate the time-consuming and error-prone aspects of manual processes. Automation ensures that certificates are always up-to-date, and employees can quickly access relevant information in real-time. This approach improves accuracy, ensures compliance, and significantly enhances operational efficiency. Furthermore, automated systems can scale with business growth, managing an increasing volume of certificates without additional human effort. As a result, businesses can unlock greater efficiency, reduce risks, and improve their ability to make informed, timely decisions.

The automatic tagging of certificates in a Building Management System (BMS) significantly enhances the accuracy of document management. By eliminating the need for manual intervention, the system ensures that each certificate is tagged consistently and correctly, based on predefined criteria. This reduces the likelihood of errors that might occur during human data entry, such as misclassification or incorrect tagging. For example, a certificate related to HVAC maintenance can automatically be tagged with the right equipment, maintenance date, and compliance standards. This level of precision guarantees that every certificate is categorized properly, improving the integrity of the system.

One of the most compelling advantages of automatic tagging is the time it saves for building management teams. Tagging certificates manually can be a time-consuming task, particularly when dealing with a large volume of documents. Automation speeds up this process by instantly applying tags to each certificate, reducing the time spent on sorting, filing, and retrieving them. With automated tagging, building managers and staff can focus on more critical tasks, such as system maintenance or tenant services, while the BMS manages the organization of documents. This not only boosts efficiency but also enhances overall productivity within the building management operation.

The automatic tagging further ensures that all certificates are systematically categorized within the BMS, leading to better organization. Each certificate, whether it's for fire safety, elevator inspection, or HVAC system certification, can be tagged with relevant keywords and metadata. These tags help in organizing documents by their type, expiration date, or associated system, making it much easier to find and manage them. This organized structure provides building managers with a clear, easily navigable document repository, allowing them to access certificates quickly when needed. Whether it's for internal reviews or regulatory inspections, this organized approach saves time and ensures documents are readily available.

In the context of building management, ensuring compliance with local regulations and safety standards is critical. Automatic tagging plays a vital role in maintaining compliance by ensuring that certificates are accurately tagged with the required regulatory information. For example, certificates related to fire safety or electrical inspections can be tagged with specific codes that correspond to local regulations. This helps managers stay on top of compliance requirements without worrying about missing important certifications. Additionally, the automated tagging system can also flag certificates nearing expiration, providing a proactive reminder to renew them, which reduces the risk of non-compliance and penalties.

Automatic tagging vastly improves the searchability of certificates within a Building Management System. When certificates are tagged with relevant metadata, users can easily search for them using specific keywords, such as the type of certificate, the equipment or system it pertains to, or the expiration date. The ability to filter certificates by different tags allows building managers to quickly retrieve important documents in case of audits, inspections, or operational needs. Whether it's pulling up a certificate for a particular piece of equipment or locating certificates that are about to expire, the system ensures that the right information is accessible in just a few clicks, saving both time and effort.

Automating the certificate tagging process brings significant cost savings to building management operations. By reducing the need for manual data entry and administrative oversight, organizations can lower their labour costs. Further, automated tagging minimizes the risk of errors, such as misplaced documents or incorrect classifications, which could lead to costly rework, fines, or missed deadlines. For instance, if an important maintenance certificate is lost or misfiled, it could delay operations or result in legal complications. Automatic tagging ensures that certificates are stored and organized in a way that prevents such risks, contributing to long-term savings and operational stability.

As building management systems expand and become more complex, the need for scalability becomes crucial. Automatic tagging makes it easier to scale document management processes without requiring significant manual effort. The system can manage a growing number of certificates, whether it's for new buildings, systems, or additional compliance regulations. Further, automated tagging can be integrated with other building management systems, such as maintenance tracking or energy management. This integration ensures that the system remains cohesive, with certificates seamlessly linked to other operational processes. This interconnectedness helps streamline overall building management, improving coordination between different departments and enhancing the effectiveness of the system.

Other technical features may be readily apparent to one skilled in the art from the following figures, descriptions, and claims.

This summary is provided to describe select concepts in a simplified form that are further described in the detailed description. This summary is not intended to identify key or essential features of the claimed subject matter, nor is it intended to be used as an aid in determining the scope of the claimed subject matter.

### BRIEF DESCRIPTION OF THE DRAWINGS

For a more complete understanding of this disclosure and its features, reference is now made to the following description, taken in conjunction with the accompanying drawings, in which:

FIG. 1 illustrates a flowchart of a method for automatic tagging of certificates in a building management system according to an embodiment of the disclosure;

FIG. 2 illustrates an exemplary flowchart for a method for automatic tagging of certificates in a building management system according to an embodiment of the disclosure;

FIG. 3a illustrates an exemplary flowchart for extracting a plurality of certificate data and a plurality of system context data from the certificate of a method for automatic tagging of certificates in a building management system, according to an embodiment of the disclosure;

FIG. 3b illustrates an exemplary flowchart for processing, and establishing relationships and hierarchies between a plurality of certificate data and a plurality of system context data of a method for automatic tagging of certificates in a building management system, according to an embodiment of the disclosure;

FIG. 3c illustrates an exemplary flowchart for creating one or more tags based on the processed plurality of certificate data and the processed plurality of system context data of a method for automatic tagging of certificates in a building management system, according to an embodiment of the disclosure;

FIG. 4 illustrates provides a system for automatic tagging of certificates in a building management system according to an embodiment of the disclosure; and

FIG. 5 illustrates a schematic diagram of a communication apparatus according to an embodiment of the disclosure.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present disclosure. Furthermore, in terms of the construction of the apparatus, one or more components of the apparatus may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

In a Building Management System (BMS), a certificate refers to a digital or physical document that authenticates specific qualifications, compliance, or operational conditions required for equipment, systems, or personnel within the building's infrastructure. These certificates often include information about safety, maintenance, and operational compliance with local regulations or standards. For example, certificates may verify that HVAC systems, fire alarms, elevators, or other critical infrastructure have passed necessary inspections and meet safety or environmental requirements. In essence, certificates serve as proof that certain systems or equipment are functioning within their legal and technical limits.

Certificates in BMS also play a crucial role in ensuring the security and reliability of the system's operational framework. For instance, security certificates are used to authenticate communications and access control within the building's network. These certificates ensure that devices within the BMS, such as sensors, controllers, and data loggers, communicate securely and are authenticated before any sensitive operational data is exchanged. Additionally, certificates can be used for ensuring the integrity of software and firmware running within BMS devices, verifying that updates and patches meet security standards and are not compromised during deployment.

Further, certificates in a BMS are essential for ongoing compliance and maintenance management. Many building systems, such as fire safety systems, electrical systems, and emergency lighting, require periodic certification to remain operationally compliant. These certificates document that the systems have been evaluated, serviced, and are in good working order, and often need to be renewed or updated regularly. Automated certificate management systems within a BMS help streamline the tracking, renewal, and validation of these certifications, ensuring the building remains compliant with regulatory standards and operational best practices. This is vital for maintaining safety, efficiency, and the overall health of the building's infrastructure.

Tagging of a certificate refers to the process of assigning specific identifiers or labels to certificates that document compliance, maintenance, or operational status of systems or equipment within the building. The primary purpose of tagging is to organize and track certificates in a structured manner, making them easily searchable and retrievable within any system. Each tag typically includes metadata such as the certificate type, expiration date, system, or equipment it applies to, and other relevant details, allowing building managers to quickly assess the status of all certificates associated with their assets.

The tagging process helps integrate certificate management with the broader BMS operations by providing a seamless way to link certificates to specific assets, devices, or systems. For instance, a certificate for a fire alarm system could be tagged with identifiers related to the system's location, installation date, inspection history, and certification details. This tag allows for efficient tracking and ensures that certificates are current, expired, or due for renewal, supporting proactive maintenance and compliance management.

Additionally, tagging certificates facilitates automated processes within the BMS, such as triggering alerts or notifications when a certificate is nearing its expiration or requires re-certification. This automation enhances operational efficiency, ensuring that compliance is continuously monitored without the need for manual checks. By leveraging tags, building operators can improve data accuracy, reduce the risk of non-compliance, and streamline certificate management tasks across any system.

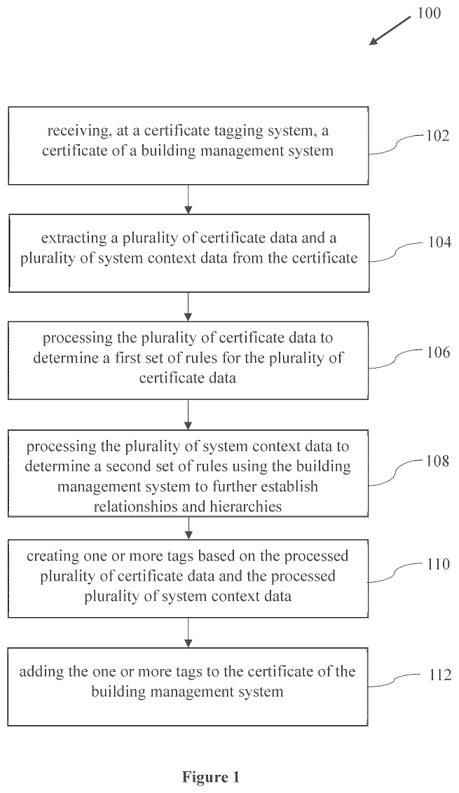

FIG. 1 illustrates a flowchart of a method for automatic tagging of certificates in a building management system hereinafter interchangeably referred to as “a method for automatic tagging 100”. The method 100 could be used with any suitable device and in conjunction with any suitable system.

The method 100 comprises receiving a certificate of a building management system (BMS) at a certificate tagging system, as shown in step 102. This step could include, for example, receiving any certificate from the BMS involving a process of obtaining official documentation that verifies the BMS's compliance with relevant standards and regulations. The certificate serves as proof that the BMS, which includes its mechanical, electrical, and safety components, has been inspected and meets the required performance criteria. The certificate may cover various aspects such as energy efficiency, safety protocols, or environmental impact, and is typically issued by a regulatory body or an accredited professional after complete evaluation.

The certificate is usually stored and recorded in a building's maintenance or compliance database for easy reference. This ensures that all relevant parties, such as building managers, maintenance teams, and auditors, can access the certificate as and when needed. The certificate may also be tagged or indexed within a digital system, making it easier to track its validity and renewal dates. In this way, the management team can ensure the BMS continues to meet regulatory standards over time.

A process of certification also serves as an essential part of the BMS as it provides a clear record that the BMS is operating within legal and industry guidelines, offering both operational and legal security. The certificate's presence can be a critical element in maintaining building safety, passing inspections, and avoiding potential fines or penalties related to non-compliance. Moreover, the process ensures that any updates or changes to the BMS can be validated against the most recent certifications.

The method 100 further comprises extracting a plurality of certificate data and a plurality of system context data from the certificate, as shown in step 104. The process of extracting the plurality of certificate data from the BMS involves retrieving a wide range of information that is detailed in the certification document. This includes specifics such as the type of system certified (e.g., HVAC, fire safety, electrical systems), the compliance standards, the scope of the certification, and the date of issuance or expiration. By systematically extracting this data, the building managers can compile a comprehensive overview of the BMS in place and the certifications that validate its operational standards. Such extracted data may be organized into structured fields, such as dates, system types, or certification numbers, enabling easy retrieval and analysis.

Along with the certificate data, extracting system context data is crucial for understanding how the certified BMS interacts with other building components and operates within the larger infrastructure. This context may include details like the specific model or configuration of the BMS, their performance benchmarks, maintenance schedules, and any operational history that might affect their compliance status. For instance, the system context data might show the last inspection or repair date, energy usage patterns, or modifications made to the system since the certification was issued. By capturing and analysing this data, the building managers can gain insights into the current condition and performance of the BMS relative to the certification criteria.

The extraction of both the certificate data and the system context data provides a powerful foundation for decision-making, system maintenance, and long-term compliance management. With this detailed information, the building managers can track whether the BMS remain in compliance with evolving regulations, anticipate upcoming certification renewals, and plan necessary system upgrades or repairs. Moreover, the integration of both types of data enables a holistic view of the BMS, facilitating proactive management and risk mitigation. By continuously updating and monitoring this data, building owners and managers can ensure ongoing safety, efficiency, and regulatory adherence for all their building systems.

The method 100 further includes processing the plurality of certificate data to determine a first set of rules for the plurality of certificate data, as shown in step 106. This processing involves analysing the extracted information from the certificate to identify common patterns and conditions that govern the compliance standards for various building systems. This step typically includes reviewing certificate details such as expiration dates, system types, regulatory codes, and certification levels. By examining this data, the BMS can identify key requirements that must be met for tagging purposes. These identified patterns or conditions then form the basis for creating a set of rules that can be applied for tagging the certificate.

The first set of rules that emerges from processing the certificate data focuses on standardizing compliance checks and maintenance schedules. For example, rules might stipulate that certain systems require re-certification every five years, or that specific inspection frequencies are mandated based on the system type or performance. Further, these first set of rules may be used to automate tagging processes within the BMS.

The method 100 further includes processing the plurality of system context data to determine a second set of rules using the BMS to further establish relationships and hierarchies, as shown in step 108. Processing the plurality of system context data to determine the second set of rules involves analysing how various BMS parameters interact with each other and their specific operational conditions. This step focus on the practical relationships between multiple parameters.

The second set of rules focuses on optimizing system performance by establishing hierarchies and dependencies within the building's infrastructure. This hierarchical structure helps determine priority actions during system failures or when scheduling preventive maintenance and tagging the certificates accordingly. By mapping these relationships, the BMS can also identify the critical systems that must be prioritized for certification renewal, inspection, or repair based on their impact on overall building operations.

In addition, these second set of rules can establish criteria for hierarchies within the BMS which also allows for better decision-making during emergencies or routine management, ensuring that building systems operate cohesively and efficiently.

As system context data is continuously updated—such as through sensors, usage logs, and maintenance records—the second set of rules can adapt dynamically to changing conditions. This ensures that the building's systems help processing the system context data that create a sophisticated, interconnected environment where the BMS can operate seamlessly.

The method 100 further includes creating one or more tags based on the processed plurality of certificate data and the processed plurality of system context data, as shown in step 110. This step involves synthesizing information from multiple data sources to generate meaningful identifiers or labels that can be used for organization, tracking, and decision-making. Certificate data typically refers to information derived from digital certificates, such as those used in secure communications (e.g., SSL/TLS certificates). This data often includes attributes like issuer, subject, validity period, public key information, and certificate type. The system context data, on the other hand, involves information about the environment or system in which a particular component operates, such as server configurations, application types, or operational conditions.

This pre-processing step 110 ensures that only the most pertinent information is considered when creating tags.

Next, the BMS uses algorithms to combine and analyse the processed data to generate meaningful tags. This may involve defining rules or applying machine learning models to identify patterns or correlations between the certificate data and the system context data. For instance, a tag might be generated that indicates whether a certificate belongs to a critical production server, or whether a certain configuration or certificate type is vulnerable to known security risks. These tags help categorize the data into actionable groups that can be easily referenced or monitored, improving the management and security of the BMS.

Finally, these tags can be used in various applications, such as automated monitoring, risk assessment, and incident response. For example, a tag associated with an expired or misconfigured certificate can trigger an alert on a monitoring system, prompting administrators to take action. Additionally, tags can be integrated with other systems or dashboards to provide a high-level overview of the system's security posture or operational health. By creating tags based on the processed certificate and system context data, organizations can improve their ability to manage large, complex systems while ensuring that security and performance issues are quickly identified and addressed.

The method 100 further comprises adding the one or more tags to the certificate of the BMS, as shown in step 112. This step involves associating final tags with each certificate based on its relevance to the building's operations and security needs. For instance, tags can be added to certificates to indicate their status, such as “valid,” “expired,” or “soon-to-expire.” These tags can also reflect the operational role of the certificate, such as “critical device” for certificates linked to essential systems like HVAC controllers, or “non-production” for those tied to testing environments. By embedding these tags directly into the certificate metadata or associated database records, administrators can quickly identify certificates that require attention or pose potential risks to the overall system.

Additionally, the tags can reflect the operational importance of the certificates in relation to the systems they protect. For example, certificates tied to essential systems like the HVAC, energy management, or security devices can be tagged as “critical_device” or “high_priority.” This allows system administrators to focus on certificates that are most crucial to the building's operation and security. Moreover, if certificates are categorized as “non-production” or linked to testing environments, they can be deprioritized, ensuring that efforts are directed toward maintaining the certificates that affect the building's core functions. Tags can also help automate workflows by triggering alerts or certificate renewal actions for tags like “expired” or “vulnerable,” streamlining maintenance efforts and reducing the risk of operational downtime or security breaches. This combination of certificate status and contextual operational information significantly improves the efficiency, security, and management of the BMS.

In an embodiment, the step (110) of creating one or more tags further comprises collecting one or more intermediary tags based on the processed plurality of certificate data and the processed plurality of system context data. Further, the method 100 includes formatting the one or more intermediary tags to standardize a format of the one or more intermediary tags and normalize at least one value of the one or more intermediary tags and identifying the one or more intermediary tags which are duplicate and resolving conflicting values of the one or more intermediary tags. Finally, the method 100 further includes categorizing the one or more intermediary tags in a group.

In another embodiment, the method 100 further comprises validating the categorized one or more intermediary tags in the group via the first set of rules and the second set of rules.

In another embodiment, the method 100 further comprises processing the validated one or more intermediary tags to form a final set of tags and tagging the certificate with the final set of tags.

In another embodiment, the plurality of certificate data is selected from a group of specific data comprising a common name, a subject alternative name(s), an issuer information, a validity period, a key usage parameter, and technical specifications. In another embodiment, the plurality of system context data is selected from a group of context data comprising a certificate name, a device type identifier, a system identifier, a zone identifier, and a domain information.

In another embodiment, the first set of rules is selected from a plurality of key strength assessment rules and a plurality of validity period rules.

In another embodiment, the processing the plurality of system context data to establish the relationships and hierarchies by setting a plurality of location rules, a plurality of equipment rules, and a plurality of integration rules. In another embodiment, the tagged certificate comprises a certificate identifier, one or more tags, and a plurality of metadata.

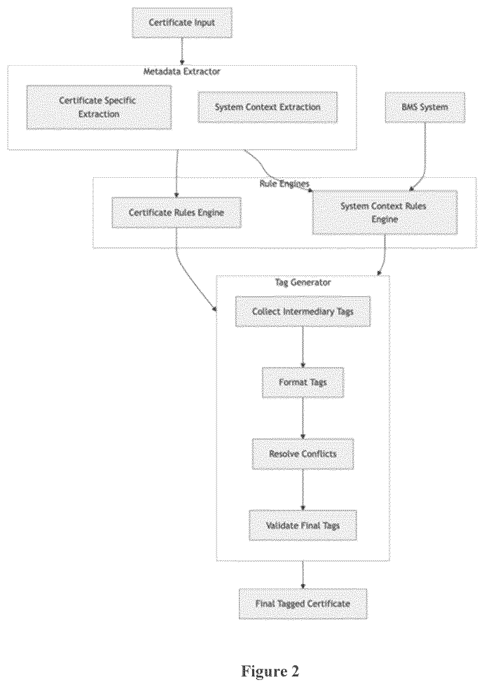

FIG. 2 illustrates an exemplary flowchart for a method for automatic tagging of certificates in the BMS according to an embodiment of the disclosure. The flowchart illustrates a sophisticated automated process for certificate tagging, which begins with the ingestion of a certificate as an input. This certificate is routed through a metadata extraction module (explained later) that extracts relevant metadata from the certificate. The extraction process is bifurcated into two distinct categories: Certificate-specific extraction, which handles tasks directly related to extracting core certificate attributes such as issuance details, expiration date, and compliance indicators, and system context extraction, which gathers contextual data from the Business Management System (BMS), thereby enhancing the contextual understanding of the certificate within the broader operational framework.

Subsequent to metadata extraction, the data is processed by a certificate rules engine (explained later) that applies domain-specific rules to validate the extracted metadata in alignment with predefined certificate management policies. This step ensures that the certificate adheres to the organizational standards, including compliance verification and usage criteria. Concurrently, as system context rule engine integrates broader BMS-driven inputs and organizational policies to apply contextual rules. The system context rules engine leverages the information fed from the BMS to generate tags that encapsulate the certificate's role in a larger operational context, such as compliance status or functional relevance to specific business processes. The bidirectional flow between the BMS and the system context rules engine ensures that the tags generated are contextually accurate and reflective of current organizational priorities.

A critical feature of this process is the iterative feedback loop between a tag generator (explained later) and the certificate-specific extraction phase, facilitated by the certificate rules engine. As new rules are applied, they feed back into the extraction and tagging process to refine and optimize the generation of tags. This iterative feedback mechanism enables continuous rule adjustment and ensures that the tagging process evolves in response to changes in compliance requirements or operational workflows. The feedback loop ensures that the tags generated are consistently updated and aligned with the most current data and rules, leading to more accurate and efficient tag creation.

Once the metadata has been processed and all rules have been applied, the data is passed to the tag generator. The tag generator is responsible for aggregating, formatting, and resolving conflicts among intermediary tags. In this phase, the tag generator first organizes and structures the tags to meet organizational standards. Subsequently, it resolves any conflicts that may arise from competing rules or overlapping contexts. Tag conflicts are managed by applying predefined resolution strategies, ensuring that the final set of tags is both consistent and meaningful. After conflict resolution, the tag generator performs a validation step, wherein the final set of tags is rigorously checked for completeness, accuracy, and adherence to business rules. The validated tags are then applied to the certificate, finalizing its digital profile with relevant metadata. The automated nature of this process reduces manual intervention, ensures real-time data accuracy, and facilitates seamless certificate management at scale, thus enhancing operational efficiency, compliance, and scalability across the enterprise.

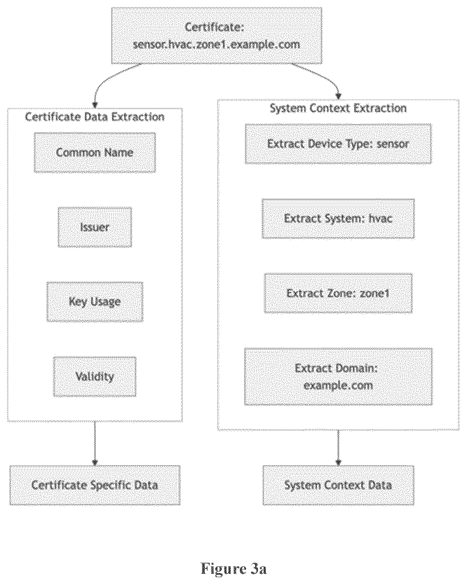

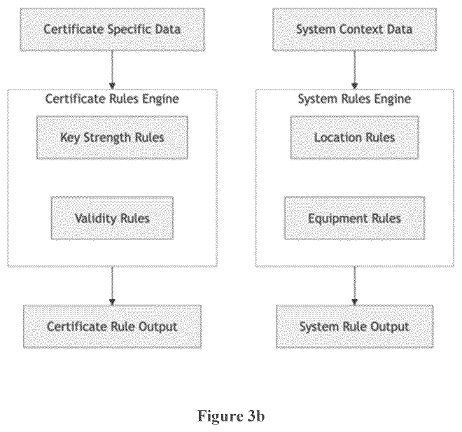

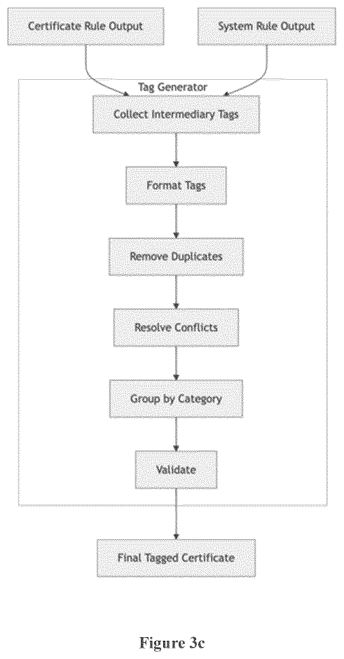

FIG. 3a illustrates an exemplary flowchart for extracting a plurality of certificate data and a plurality of system context data from a certificate in a building management system according to an embodiment of the disclosure. The process explains how the metadata is extracted from the certificate. The system extracts information directly from the certificate. The extracted data includes common name: the common name from the certificate, issuer: the issuer of the certificate, key usage: the intended use of the certificate's key, and validity: information regarding the certificate's validity period. All these extracted metadata are then combined to form a certificate specific data.

The system context extraction utilizes the contextual information from the BMS, which may include: extract device type: identifies the type of device the certificate is associated with e.g. a “sensor”; extract system: identifies the system the device belongs to e.g. “hvac” indicating heating, ventilation, and air conditioning; extract zone: specifies the zone or location within the system e.g. “zone1”; extract domain: identifies the domain the certificate e.g. “example.com”; etc. These items are combined to produce a system context data.

The flowchart details that both the certificate specific data and the system context data are outputs of the method shown in the FIG. 3b. The parallel processing illustrates how both certificate-intrinsic and external contextual information are extracted to provide a comprehensive understanding of the metadata of the certificate and BMS.

FIG. 3b illustrates an exemplary flowchart for processing and establishing relationships & hierarchies between a plurality of certificate data and a plurality of system context data in a building management system according to an embodiment of the disclosure.

FIG. 3b is a continuation of the logic presented in the FIG. 3a. The processing of the certificate specific data and the system context data is shown in the FIG. 3b. The certificate specific data is fed to a certificate rules engine, where specific rules are applied to the certificate specific data for further evaluation. The factors being applied here are key strength rules and validity rules. The key strength rules are a subset of rules within the certificate rule engine focusing on the cryptographic strength of the certificate's key, and the validity rules is another subset of rules within the certificate rule engine evaluating the certificate's validity period and other relevant attributes. The result of the evaluation process is certificate rule output.

The system context data is fed to a system rules engine for further processing. The system rules engine processes the system context data to check the data against location and/or equipment rules. The location rules are a subset of rules focusing on geographical restrictions or allowances and equipment rules and the equipment rules are another subset evaluating compatibility with specific hardware or software. The result of the evaluation process is a system rule output.

The two mentioned processes run independently of each other. Both processes take their respective input data, apply their unique rule sets, and generate separate outputs. There is no explicit interaction or merging of the two outputs shown in this particular diagram. These outputs are combined later (FIG. 3c) in a step not shown in the visual representation of FIG. 3b.

FIG. 3c illustrates an exemplary flowchart for creating one or more tags based on the output of FIG. 3b in a building management system according to an embodiment of the disclosure. The flowchart is depicting the process of generating a final tagged certificate. The process begins with two inputs-the certificate rule output contains the data that is derived from rules specific to the certificate and the system rule output contains the data that is derived from general system rules (as shown in FIG. 3b).

These two inputs feed into the tag generator, which then performs the following steps. At first, the tag generator collects intermediary tags and gathers all relevant tags from the inputs. Then the tags are formatted to a standardizes format of the various collected tags. Then the tag generator eliminates any redundant or duplicate tags from the various formatted tags. Then, rules are used to resolve conflicts and addresses any inconsistencies or contradictions between tags.

The tag generator further groups the tags into various categories. The tag generator further checks the validity and accuracy of the grouped and formatted tags. After validation, the tag generator concludes with the output of a final tagged certificate tagged with all the final validated tags.

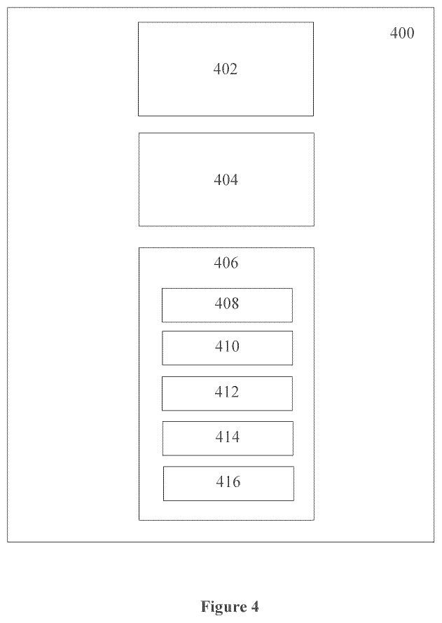

FIG. 4 illustrates a certificate tagging system 400 for automatic tagging of certificates according to an embodiment of the disclosure. The certificate tagging system 400 comprises a metadata extractor module 402, a rules engine 404, and a tag generation module 406. The metadata extractor module 402 receives a certificate of a building management system (BMS) and is further configured to extract a plurality of certificate data and a plurality of system context data from the certificate.

The rules engine 404 processes the plurality of certificate data to determine a first set of rules for the plurality of certificate data and is further configured to process the plurality of system context data to determine a second set of rules using the building management system to further establish relationships and hierarchies.

The tag generation module 406 creates one or more tags based on the processed plurality of certificate data and the processed plurality of system context data. The tag generation module 406 then adds the one or more tags to the certificate of the building management system.

In an embodiment, the tag generation module 406 includes a tag collection module 408, a formatting module 410, a conflict resolution module 412, and a categorization module 414. The tag collection module 408 collects one or more intermediary tags based on the processed plurality of certificate data and the processed plurality of system context data. The formatting module 410 formats the one or more intermediary tags to standardize a format of the one or more intermediary tags and normalize at least one value of the one or more intermediary tags. The conflict resolution module 412 identifies the one or more intermediary tags which are duplicate and resolve conflicting values of the one or more intermediary tags. The categorization module 414 categorizes the one or more intermediary tags in a group.

In an embodiment, the certificate tagging system 400 includes a tagging module 416 for validating the categorized one or more intermediary tags in the group via the first set of rules and second set of rules.

In an embodiment, the tagging module 416 is further configured to process the validated one or more intermediary tags to form a final set of tags and further configured to tag the certificate with the final set of tags.

In another embodiment, the plurality of certificate data is selected from a group of specific data comprising a common name, a subject alternative name(s), an issuer information, a validity period, a key usage parameter, and technical specifications. In another embodiment, the plurality of system context data is selected from a group of context data comprising a certificate name, a device type identifier, a system identifier, a zone identifier, and a domain information.

In another embodiment, the first set of rules is selected from a plurality of key strength assessment rules and a plurality of validity period rules.

In another embodiment, the rules engine 404 can process the plurality of system context data to establish the relationships and hierarchies by setting a plurality of location rules, a plurality of equipment rules, and a plurality of integration rules.

In another embodiment, the tagged certificate comprises a certificate identifier, one or more tags, and a plurality of metadata.

In another embodiment, the system 400 automatically fetches the certificate and the second set of rules from the building management system.

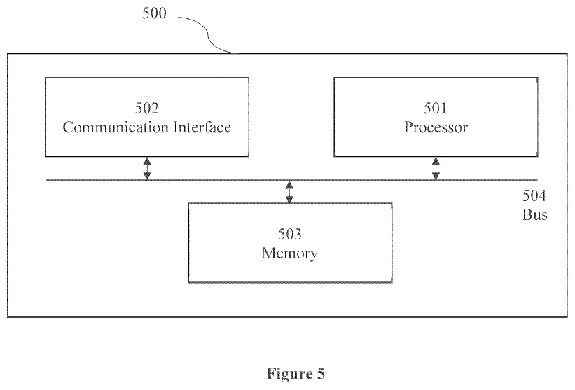

FIG. 5 illustrates a schematic diagram of an apparatus 500 for automatic tagging of certificates according to an embodiment of the disclosure. The polling apparatus 500 includes a processor 501, a communication interface 502, and a memory 503. The processor 501, the communication interface 502, and the memory 503 may be connected to each other via a bus 504. The bus 504 may be a peripheral component interconnect (peripheral component interconnect, PCI) bus, an extended industry standard architecture (extended industry standard architecture, EISA) bus, or the like. The bus 504 may be classified into an address bus, a data bus, a control bus, and the like. For ease of representation, the bus is represented by using only one line in FIG. 5, but it does not indicate that there is only one bus or one type of bus. The processor 501 may be a central processing unit (central processing unit, CPU), a network processor (network processor, NP), or a combination of a CPU and an NP. The processor may further include a hardware chip. The hardware chip may be an application-specific integrated circuit (application-specific integrated circuit, ASIC), a programmable logic device (programmable logic device, PLD), or a combination thereof. The PLD may be a complex programmable logic device (complex programmable logic device, CPLD), a field-programmable gate array (field-programmable gate array, FPGA), generic array logic (Generic Array Logic, GAL), or any combination thereof. The memory 503 may be a volatile memory or a non-volatile memory or may include a volatile memory and a non-volatile memory. The non-volatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM), and is used as an external cache.

The connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter may be described herein in terms of functional and/or logical block components, and with reference to symbolic representations of operations, processing tasks, and functions that may be performed by various computing components or products. It should be appreciated that the various block components shown in the figures may be realized by any number of hardware components configured to perform the specified functions. For example, an embodiment of a system or a component may employ various integrated circuit components, e.g., memory elements, digital signal processing elements, logic elements, look-up tables, or the like, which may conduct a variety of functions under the control of one or more microprocessors or other control products. Furthermore, embodiments of the subject matter described herein can be stored on, encoded on, or otherwise embodied by any suitable non-transitory computer-readable medium as computer-executable instructions or data stored thereon that, when executed (e.g., by a processing system), facilitate the processes described above.

Usually, various embodiments of this disclosure may be implemented by hardware or a dedicated circuit, software, logic, or any combination thereof. Some aspects may be implemented by the hardware, and other aspects may be implemented by firmware or software, and may be performed by a controller, a microprocessor, or another computing device. Although aspects of embodiments of this disclosure are shown and described as block diagrams, flowcharts, or some other figures, it should be understood that the blocks, apparatuses, systems, technologies, or methods described in this specification may be implemented as, for example, non-limiting examples, hardware, software, firmware, dedicated circuits or logic, general-purpose hardware or controllers or other computing devices, or a combination thereof.

This disclosure further provides at least one computer program product tangibly stored on a non-transitory computer-readable storage medium. The computer program product includes computer-executable instructions, such as instructions included in a program module, which are executed in a device on a real or virtual processor of a target, to perform the processes/methods described above with reference to the accompanying drawings. Usually, a program module includes a routine, a program, a library, an object, a class, a component, a data structure, or the like that performs a particular task or implements a particular abstract data type. In various embodiments, functions of the program module may be combined, or a function of the program module may be as needed. Machine-executable instructions for the program module may be executed locally or within a distributed device. In the distributed device, the program module may be located in local and remote storage media.

Computer program code for implementing the method disclosed in this disclosure may be written in one or more programming languages. The computer program code may be provided for a processor of a general-purpose computer, a dedicated computer, or another programmable data processing apparatus, so that when the program code is executed by the computer or another programmable data processing apparatus, a function/operation specified in the flowchart and/or the block diagram is implemented. The program code may be completely executed on a computer, partially executed on a computer, independently performed as a software package, partially executed on a computer, and partially executed on a remote computer, or completely executed on a remote computer or a server.

In context of this disclosure, the computer program code or related data may be borne in any appropriate carrier, so that the device, the apparatus, or the processor can perform various processing and operations described above. An example of the carrier includes a signal, a computer-readable medium, and the like. An example of the signal may include propagating signals in electrical, optical, radio, sound, or other forms, such as carrier waves and infrared signals.

The computer-readable medium may be any tangible medium that includes or stores a program used for or related to an instruction execution system, apparatus, or device. The computer-readable medium may be a computer-readable signal medium or a computer-readable storage medium. The computer-readable medium may include but is not limited to an electronic, magnetic, optical, electromagnetic, infrared, or semiconductor system, apparatus, or device, or any suitable combination thereof. A more detailed example of the computer-readable storage medium includes an electrical connection with one or more wires, a portable computer disk, a hard disk, a random access memory (RAM), a read-only memory (ROM), an erasable programmable read-only memory (EPROM or flash memory), an optical storage device, a magnetic storage device, or any suitable combination thereof.

In an exemplary embodiment, in a Building Management System (BMS), a Fire Safety Certificate for the building's fire alarm system serves as a critical document that certifies the system's compliance with local safety regulations and operational standards. This certificate ensures that the fire alarm system has been professionally installed, regularly inspected, and maintained to meet safety requirements. The tagging process within the BMS allows this certificate to be associated with specific data points, ensuring that it is easily accessible and accurately tracked. Tags can be assigned to the certificate based on the building's operational needs, regulatory requirements, and system-specific attributes.

One important aspect of tagging the Fire Safety Certificate is the certificate type tag. The tag for this certificate would clearly indicate that it pertains to fire safety, specifically the fire alarm system. This tag helps categorize the certificate and differentiates it from other types of certificates, such as HVAC maintenance certificates or elevator inspection certificates. Tagging by certificate type ensures that BMS can quickly locate certificates based on the specific system or service they are associated with. For example, the BMS can easily distinguish certificates for life safety systems, like fire alarms, from certificates related to energy systems or lighting control, facilitating targeted compliance monitoring, and reporting.

The next crucial tags for the Fire Safety Certificate would be those associated with asset/system and location. The system-specific tag links the certificate directly to the fire alarm system, enabling the BMS to track its condition and compliance status. For instance, the fire alarm system might be tagged with “Fire Alarm System—Zone A” or “Fire Safety Floor 3,” pinpointing the exact location within the building. This is particularly helpful in large buildings or multi-building complexes where different zones or sections may require individual compliance checks. When a certificate is tagged with location-specific identifiers, it ensures that if maintenance, testing, or renewal is needed, the right system in the correct location is addressed. Additionally, these tags allow for efficient audits and inspections, ensuring that no area of the building is overlooked in terms of the fire safety compliance.

Dates are another critical component of the tagging system for the Fire Safety Certificate. Tags related to the issue date, expiration date, and next inspection due help streamline the scheduling and tracking of certification requirements. For example, the issue date tag would indicate when the certificate was originally issued, while the expiration date tag marks the validity period of the certificate, typically one year or more depending on local regulations. The next inspection due tag helps building managers proactively schedule the next inspection or recertification, ensuring that there is no gap in the certification status. By automating this process through the BMS, building operators can receive timely reminders to arrange for re-certification or maintenance, reducing the risk of non-compliance or safety lapses.

The regulatory standard tag within the BMS ensures that the certificate aligns with the relevant industry or government regulations. For example, the Fire Safety Certificate may be tagged with the regulatory standard “NFPA 72,” which is the National Fire Alarm and Signaling Code, to indicate that the fire alarm systems meet specific requirements set forth by the National Fire Protection Association. This tag helps verify that the BMS is compliant with local and national safety standards, offering assurance to both building operators and regulatory bodies that the system is functioning as required. In addition to this, a certification ID tag provides a unique identifier for the certificate, which can be used to cross-reference the certificate in a BMS database, making it easier to track and retrieve during inspections or audits.

Finally, the tagging system allows for the inclusion of operational status and inspection results, which are essential for maintaining ongoing compliance. A status tag such as “Passed” or “Failed” indicates whether the system has successfully met the requirements of the inspection, while a next action tag could suggest if corrective actions are required. For example, if the fire alarm system inspection reveals minor issues that need addressing before re-certification, the tag could be updated to reflect the need for repairs or further testing. This dynamic tracking of the certificate's status within the BMS ensures that the fire alarm system is continually monitored and maintained in an optimal condition.

Overall, the detailed tagging of certificates within the BMS ensures that compliance and safety requirements are meticulously tracked and easily accessible. It enables building managers to efficiently manage certifications across multiple systems, ensures that no certification is overlooked, and helps streamline the process of renewing or updating certificates. With automated alerts and reminders, this tagging system reduces the risk of lapses in certification, contributing to a safer, more compliant building environment.

The automatic tagging of certificates in the BMS significantly enhances the accuracy of document management. By eliminating the need for manual intervention, the system ensures that each certificate is tagged consistently and correctly based on predefined criteria. This reduces the likelihood of errors that might occur during human data entry, such as misclassification or incorrect tagging. For example, a certificate related to HVAC maintenance can automatically be tagged with the right equipment, maintenance date, and compliance standards. This level of precision guarantees that every certificate is categorized properly, thereby improving the integrity of the BMS.

One of the most compelling advantages of automatic tagging is the time it saves for building management teams. Tagging certificates manually can be a time-consuming task, particularly when dealing with a large volume of documents. Automation speeds up this process by instantly applying tags to each certificate, reducing the time spent on sorting, filing, and retrieving them. With automated tagging, building managers and staff can focus on more critical tasks, such as system maintenance or tenant services, while the BMS manages the organization of documents. This not only boosts efficiency but also enhances overall productivity within the building management operation.

The automatic tagging further ensures that all certificates are systematically categorized within the BMS, leading to better organization. Each certificate, whether it's for fire safety, elevator inspection, or HVAC system certification, can be tagged with relevant keywords and metadata. These tags help in organizing documents by their type, expiration date, or associated system, making it much easier to find and manage them. This organized structure provides building managers with a clear, easily navigable document repository, allowing them to access certificates quickly when needed. Whether it's for internal reviews or regulatory inspections, this organized approach saves time and ensures documents are readily available.

In the context of building management, ensuring compliance with local regulations and safety standards is critical. Automatic tagging plays a vital role in maintaining compliance by ensuring that certificates are accurately tagged with the required regulatory information. For example, certificates related to fire safety or electrical inspections can be tagged with specific codes that correspond to local regulations. This helps managers stay on top of compliance requirements without worrying about missing important certifications. Additionally, the automated tagging system can also flag certificates nearing expiration, providing a proactive reminder to renew them, which reduces the risk of non-compliance and penalties.

Automatic tagging vastly improves the searchability of certificates within the BMS. When certificates are tagged with relevant metadata, users can easily search for them using specific keywords, such as the type of certificate, the equipment or system it pertains to, or the expiration date. The ability to filter certificates by different tags allows building managers to quickly retrieve important documents in case of audits, inspections, or operational needs. Whether it's pulling up a certificate for a particular piece of equipment or locating certificates that are about to expire, the system ensures that the right information is accessible in just a few clicks, saving both time and effort.

Automating the certificate tagging process brings significant cost savings to building management operations. By reducing the need for manual data entry and administrative oversight, organizations can lower their labour costs. Further, automated tagging minimizes the risk of errors, such as misplaced documents or incorrect classifications, which could lead to costly rework, fines, or missed deadlines. For instance, if an important maintenance certificate is lost or misfiled, it could delay operations or result in legal complications. Automatic tagging ensures that certificates are stored and organized in a way that prevents such risks, contributing to long-term savings and operational stability.

As the BMS expands and become more complex, the need for scalability becomes crucial. Automatic tagging makes it easier to scale document management processes without requiring significant manual effort. The system can manage a growing number of certificates, whether it's for new buildings, systems, or additional compliance regulations. Furthermore, automated tagging can be integrated with other BMS, such as maintenance tracking or energy management. This integration ensures that the system remains cohesive, with certificates seamlessly linked to other operational processes. This interconnectedness helps streamline overall building management, improving coordination between different departments and enhancing the effectiveness of the system.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, products, features, or components may be present in an embodiment of the depicted subject matter. In addition, certain terminology may also be used herein for the purpose of reference only, and thus are not intended to be limiting.

The foregoing detailed description is merely exemplary in nature and is not intended to limit the subject matter of the application and uses thereof. Furthermore, there is no intention to be bound by any theory presented in the preceding background, brief summary, or detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

We claim:

1. A method for automatic tagging of certificates, comprising:
receiving, at a certificate tagging system, a certificate of a building management system;
extracting a plurality of certificate data and a plurality of system context data from the certificate;
processing the plurality of certificate data to determine a first set of rules for the plurality of certificate data and processing the plurality of system context data to determine a second set of rules using the building management system to further establish relationships and hierarchies;
creating one or more tags based on the processed plurality of certificate data and the processed plurality of system context data; and
adding the one or more tags to the certificate of the building management system.

2. The method as claimed in claim 1, wherein the creating one or more tags comprising:
collecting one or more intermediary tags based on the processed plurality of certificate data and the processed plurality of system context data;
formatting the one or more intermediary tags to standardize a format of the one or more intermediary tags and normalize at least one value of the one or more intermediary tags;
identifying the one or more intermediary tags which are duplicate and resolving conflicting values of the one or more intermediary tags; and
categorizing the one or more intermediary tags in a group.

3. The method as claimed in claim 2, further comprising validating the categorized one or more intermediary tags in the group via the first set of rules and the second set of rules.

4. The method as claimed in claim 3, further comprising:
processing the validated one or more intermediary tags to form a final set of tags; and
tagging the certificate with the final set of tags.

5. The method as claimed in claim 1, wherein the plurality of certificate data is selected from a group of specific data comprising a common name, a subject alternative name(s), an issuer information, a validity period, a key usage parameter, and technical specifications.

6. The method as claimed in claim 1, wherein the plurality of system context data is selected from a group of context data comprising a certificate name, a device type identifier, a system identifier, a zone identifier, and a domain information.

7. The method as claimed in claim 1, wherein the first set of rules is selected from a plurality of key strength assessment rules and a plurality of validity period rules.

8. The method as claimed in claim 1, wherein processing the plurality of system context data to establish the relationships and hierarchies by setting a plurality of location rules, a plurality of equipment rules, and a plurality of integration rules.

9. The method as claimed in claim 1, wherein the tagged certificate comprises a certificate identifier, one or more tags, and a plurality of metadata.

10. A certificate tagging system for automatic tagging of certificates, comprising:
a metadata extractor module configured to receive a certificate of a building management system and further configured to extract a plurality of certificate data and a plurality of system context data from the certificate;
a rules engine configured to process the plurality of certificate data to determine a first set of rules for the plurality of certificate data and further configured to process the plurality of system context data to determine a second set of rules using the building management system to further establish relationships and hierarchies; and
a tag generation module configured to create one or more tags based on the processed plurality of certificate data and the processed plurality of system context data and further configured to add the one or more tags to the certificate of the building management system.

11. The certificate tagging system as claimed in claim 1, wherein the tag generation module comprising:
a tag collection module configured to collect one or more intermediary tags based on the processed plurality of certificate data and the processed plurality of system context data;
a formatting module configured to format the one or more intermediary tags to standardize a format of the one or more intermediary tags and normalize at least one value of the one or more intermediary tags;
a conflict resolution module configured to identify the one or more intermediary tags which are duplicate and resolve conflicting values of the one or more intermediary tags; and
a categorization module configured to categorize the one or more intermediary tags in a group.

12. The certificate tagging system as claimed in claim 11, further comprising a tagging module configured to validate the categorized one or more intermediary tags in the group via the first set of rules and second set of rules.

13. The certificate tagging system as claimed in claim 12, wherein the tagging module further configured to process the validated one or more intermediary tags to form a final set of tags and further configured to tag the certificate with the final set of tags.

14. The certificate tagging system as claimed in claim 10, wherein the plurality of certificate data is selected from a group of specific data comprising a common name, a subject alternative name(s), an issuer information, a validity period, a key usage parameter, and technical specifications.

15. The certificate tagging system as claimed in claim 10, wherein the plurality of system context data is selected from a group of context data comprising a certificate name, a device type identifier, a system identifier, a zone identifier, and a domain information.

16. The certificate tagging system as claimed in claim 10, wherein the first set of rules is selected from a plurality of key strength assessment rules and a plurality of validity period rules.

17. The certificate tagging system as claimed in claim 10, wherein the rules engine further configured to process the plurality of system context data to establish the relationships and hierarchies by setting a plurality of location rules, a plurality of equipment rules, and a plurality of integration rules.

18. The certificate tagging system as claimed in claim 10, wherein the tagged certificate comprises a certificate identifier, one or more tags, and a plurality of metadata.

19. The certificate tagging system as claimed in claim 10, wherein the system automatically fetches the certificate, and the second set of rules from the building management system.

20. A non-transitory computer-readable medium having stored thereon computer-readable instructions that, when executed by a processor, cause the processor to execute a method for automatic tagging of certificates, comprising:
receiving a certificate of a building management system;
extracting a plurality of certificate data and a plurality of system context data from the certificate;
processing the plurality of certificate data to determine a first set of rules for the plurality of certificate data and processing the plurality of system context data to determine a second set of rules using the building management system to further establish relationships and hierarchies;
creating one or more tags based on the processed plurality of certificate data and the processed plurality of system context data; and
adding the one or more tags to the certificate of the building management system.
